(19) United States
(12) Patent Application Publication
(10) Pub. No.: US 2017/0343994 A1
(43) Pub. Date: Nov. 30, 2017

(54) MANUFACTURING MANAGEMENT DEVICE FOR CONTROLLING MANUFACTURING CELLS IN WHICH MAINTENANCE WORK IS CONDUCTED

(71) Applicant: FANUC CORPORATION, Yamanashi (JP)

(72) Inventors: Hiroji Nishi, Yamanashi (JP); Muneyuki Tsuda, Yamanashi (JP)

(73) Assignee: FANUC CORPORATION, Yamanashi (JP)

(21) Appl. No.: 15/608,311

(22) Filed: May 30, 2017

(30) Foreign Application Priority Data
May 30, 2016 (JP) 2016-107616

(51) Int. Cl. G05B 19/418; G06Q 10/06; G06Q 50/04

(52) U.S. Cl. CPC G05B 19/41865; G06Q 50/04; G06Q 10/0631; G06Q 10/0633

(57) ABSTRACT

A manufacturing management device includes first cell planning device connected to the manufacturing machine of first manufacturing cell, and second cell planning device connected to the manufacturing machine of second manufacturing cell. The planning part of the first cell planning device calculates quantity of operation that would be left unfinished with respect to the quantity stipulated in a manufacturing plan. The first cell planning device transmits a request for transfer including information on the quantity of operation that would be left unfinished to the second cell planning device. The second cell planning device modifies at least one of the operation period and the period of maintenance work of the manufacturing machine in the second manufacturing cell so as to increase the quantity of operation during the predetermined period.

### BACKGROUND OF THE INVENTION

### 1. Field of the Invention

The present invention relates to a manufacturing management device for controlling a plurality of manufacturing machines.

### 2. Description of the Related Art

It is known conventionally that productivity is improved by manufacturing machines for conducting operations such as machining and welding components in manufacturing factories. It is also known that a plurality of manufacturing machines are used for the manufacturing of articles in manufacturing factories. When the plurality of manufacturing machines are used, the workload for producing articles is divided among the plurality of manufacturing machines. Manufacturing machines need to be placed under routine maintenance work for, e.g., changing tools. Manufacturing machines need to be placed under non-routine maintenance work for, e.g., changing deteriorated components or, when a trouble has occurred, for the inspection of the cause of the trouble.

The period for conducting maintenance work is usually set in advance. For example, the operator can designate the period of one hour before the start of work in a day as time for maintenance work. Alternatively, the operator can designate the last day of the week as time for maintenance work. Alternatively, the operator can set a period for maintenance work while the factory is not in operation during holidays.

Japanese Patent No. 5172386B discloses a device for changing a maintenance plan and an operation plan so as to conduct maintenance work while the manufacturing device is not in operation. Japanese Patent No. 5352486B discloses a device for preparing a maintenance plan of a plurality of manufacturing machines so that the maintenance work for the manufacturing machines is conducted at the same time. Japanese Unexamined Patent

Publication No. 4-260971A discloses a maintenance system that, when conducting an unplanned emergency maintenance work, changes the manufacturing schedule so as to conduct a planned maintenance work.

### SUMMARY OF THE INVENTION

In a manufacturing factory, when the period of maintenance work is not long enough, the maintenance work may not be fully conducted. When the maintenance work is not fully conducted, the manufacturing machines may have a serious malfunction or may have a trouble in which the cause is not identified, or a declined performance of the manufacturing machines may continue for a long period. As a result, the productivity of the whole factory may deteriorate. Manufacturing machines are taken out of operation during the maintenance work. When manufacturing machines are taken out of operation, the operating rate deteriorates. Therefore, it is preferable to operate manufacturing machines and conduct maintenance work in an efficient manner.

With conventional techniques, it takes time to conduct maintenance work, leaving insufficient time for operating manufacturing machines. Setting time for maintenance work may result in a decline of productivity in the manufacturing factory, and make it impossible to finish the quantity of operation stipulated in the manufacturing plan.

A manufacturing management device according to the present invention is connected to a production planning device for setting a manufacturing plan of articles and controls first manufacturing cell including a manufacturing machine and second manufacturing cell including a manufacturing machine. The manufacturing management device includes first cell planning device connected to the manufacturing machine of the first manufacturing cell, and second cell planning device connected to the manufacturing machine of the second manufacturing cell. Each of the cell planning devices includes a reception part for receiving a request for maintenance work from the manufacturing machine and quantity stipulated in the manufacturing plan for a predetermined period from the production planning device. Each of the cell planning devices includes a planning part for setting a period during which the manufacturing machine is operated and a period during which the maintenance work is conducted based on the request for maintenance work and the manufacturing plan, and a transmission part for transmitting predetermined information to the other cell planning device. The planning part of the first cell planning device, when the quantity of operation stipulated in the manufacturing plan will not be accomplished, calculates quantity of operation that would be left unfinished with respect to the quantity stipulated in the manufacturing plan. The transmission part of the first cell planning device transmits a request for transfer including information on the quantity of operation that would be left unfinished to the second cell planning device. The planning part of the second cell planning device, when the request for transfer has been received from the first cell planning device, modifies at least one of the operation period and the period of maintenance work of the manufacturing machines in the second manufacturing cell so as to increase the quantity of operation during the predetermined period.

In the above-described invention, the manufacturing management device can include three or more cell planning devices connected in relation to three or more manufacturing cells. Each of the cell planning devices can be configured in such a manner that, when a requested quantity of operation will not be accomplished in the cell planning device, the cell planning device executes a transfer control for, after calculating quantity of operation that would be left unfinished with respect to the requested quantity of operation, transmitting to another cell planning device a request for transfer including information on the quantity of operation that would be left unfinished. A plurality of the cell planning devices can repeat the transfer control until it is found that the quantity of operation stipulated in the manufacturing plan will be accomplished.

In the above-described invention, the manufacturing management device can be configured to be connected to the production planning device and to control a third manufacturing cell including a manufacturing machine.

The manufacturing management device can further include third cell planning device connected to the manufacturing machine of the third manufacturing cell. When the quantity of operation indicated by the request for transfer will not be accomplished in the second manufacturing cell, the planning part of the second cell planning device can calculate quantity of operation that would be left unfinished with respect to the request for transfer. The transmission part of the second cell planning device can transmit to the third cell planning device a request for transfer including information on the quantity of operation that would be left unfinished. The planning part of the third cell planning device, when the request for transfer has been received from the second cell planning device, can modify at least one of the operation period and the period of maintenance work of the manufacturing machine in the third manufacturing cell so as to increase quantity of operation during the predetermined period.

### BRIEF DESCRIPTION OF THE DRAWINGS

FIG. 1 is a block diagram of a first production system according to an embodiment.

FIG. 2 is a flow chart of a control of the first production system according to the embodiment.

FIG. 3 is a block diagram of a second production system according to the embodiment.

FIG. 4 is a flow chart of a control of the second production system according to the embodiment.

### DETAILED DESCRIPTION

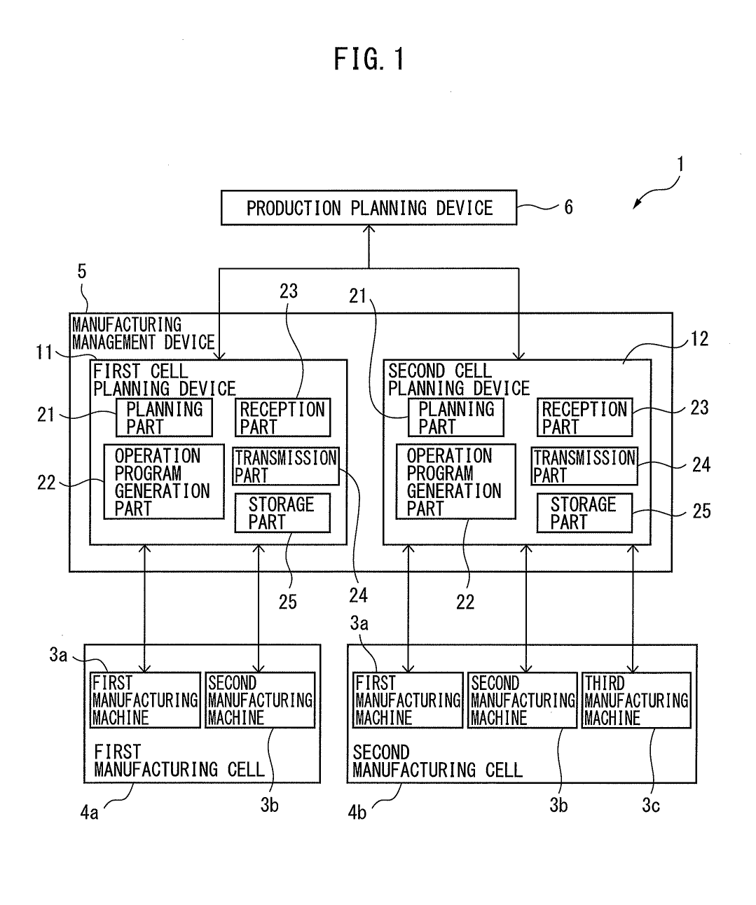

Referring to FIGS. 1 to 4, a manufacturing management device according to an embodiment will be described. The manufacturing management device according to the present embodiment controls manufacturing machines disposed in a factory or the like.

FIG. 1 is a block diagram of a first production system according to the present embodiment. The production system 1 includes a plurality of manufacturing cells. In the example illustrated in FIG. 1, the production system 1 includes first manufacturing cell 4a and second manufacturing cell 4b. A manufacturing cell is a group of manufacturing machines, their operators and other elements for conducting predetermined operation. A manufacturing cell may be established in any way. For example, a manufacturing cell is established by grouping similar operation processes together. Alternatively, a manufacturing cell is established by arranging the operation processes according to the order of execution and by grouping the operation processes so that each group of operation is executed within a predetermined period.

Each of the manufacturing cells 4a, 4b includes at least one manufacturing machine. According to the present embodiment, the first manufacturing cell 4a includes a first manufacturing machine 3a and a second manufacturing machine 3b. The second manufacturing cell 4b includes a first manufacturing machine 3a, a second manufacturing machine 3b as well as a third manufacturing machine 3c. Each of the manufacturing cells 4a, 4b may include an operator.

For each of the manufacturing machines 3a to 3c, any machine for producing an article may be employed. For example, a manufacturing machine may be a robotic device for conducting predetermined operation such as attaching or welding components. A manufacturing machine may also be any machine for manufacturing an article such as a machine tool, a printing machine, or a coating machine.

The production system 1 includes a manufacturing management device 5 for controlling the manufacturing cells 4a, 4b. The manufacturing management device 5 includes a plurality of cell planning devices 11, 12. According to the present embodiment, for each manufacturing cell there is a corresponding cell planning device. A cell planning device is also referred to as a cell control device. The first cell planning device 11 is connected to the manufacturing machines 3a, 3b included in the first manufacturing cell 4a. The first cell planning device 11 controls the manufacturing machines 3a, 3b included in the first manufacturing cell 4a. The second cell planning device 12 is connected to the manufacturing machines 3a to 3c included in the second manufacturing cell 4b. The second cell planning device 12 controls the manufacturing machines 3a to 3c included in the second manufacturing cell 4b. The first cell planning device 11 and the second cell planning device 12 are configured to be mutually communicable by communication device.

Each of the manufacturing machines 3a to 3c includes a machine control device for controlling the manufacturing machine. The cell planning devices 11, 12 are configured to be mutually communicable with the machine control devices by communication device. The cell planning devices 11, 12 acquire the operation status of the manufacturing machines 3a to 3c from the machine control devices and transmit operation commands to the machine control devices.

The production system 1 includes a production planning device 6 for setting a manufacturing plan of articles. The production planning device 6 is configured to be communicable with the cell planning devices 11, 12. The production planning device 6 according to the present embodiment controls the production of the articles of the whole factory.

According to the present embodiment, the manufacturing cells 4a, 4b are disposed in the factory where the articles are manufactured. In contrast, the cell planning devices 11, 12 and the production planning device 6 may be disposed in a building different from the factory. For example, the cell planning devices 11, 12 may be disposed in another building in the premises of the manufacturing factory. In such a case, the cell planning devices 11, 12 and the manufacturing cells 4a, 4b can be connected, for example, via a network such as an intranet. The cell planning devices 11, 12 can be connected to each other via a network such as an intranet. The production planning device 6 may be disposed in an office located in an area away from the manufacturing factory. The production planning device 6 is connected to the cell planning devices 11, 12 to be mutually communicable by communication device, for example, via a network such as the Internet.

Each of the cell planning devices 11, 12 includes an arithmetic processing device having a CPU (Central Processing Unit), a RAM (Random Access Memory), and a ROM (Read Only Memory) and the like connected to one another through the bus. The production planning device 6 and the machine control devices provided for the manufacturing machines 3a to 3c also include an arithmetic processing device having a CPU and the like.

The production planning device 6 according to the present embodiment sets a manufacturing plan of the manufacturing of articles in the whole factory, which is to be assigned to the manufacturing management device 5. The production planning device 6 separately transmits respective manufacturing plan information to the cell planning devices 11, 12. The manufacturing plan information includes contents of respective operations to be conducted in the manufacturing cells 4a, 4b during a predetermined period. In other words, the manufacturing plan information contains quantity of articles in which the operation is conducted during the predetermined period. For example, the first cell planning device 11 receives quantity of articles in which the operation is conducted in the first manufacturing cell 4a during the predetermined period from the production planning device 6. The first cell planning device 11 transmits operation programs to the first manufacturing machine 3a and the second manufacturing machine 3b in accordance with the manufacturing plan.

During actual operations, the cell planning devices 11, 12 acquire the status of manufacturing such as completion of processing of an article. The cell planning devices 11, 12 transmit manufacturing result information to the production planning device 6. For example, the cell planning devices 11, 12 acquire the quantity of articles in which the operation is actually conducted during the predetermined period. The cell planning devices 11, 12 transmit to the production planning device 6 manufacturing result information including the quantity of articles in which the operation is actually conducted. The production planning device 6 can prepare manufacturing plan information for the next period based on the manufacturing result information.

The first cell planning device 11 includes a reception part 23 for receiving information from an external device. The reception part 23 receives requests for maintenance work from the manufacturing machines 3a, 3b and the manufacturing plan for the first manufacturing cell 4a from the production planning device 6. The first cell planning device 11 includes a transmission part 24 for transmitting predetermined information to an external device. The first cell planning device 11 includes a storage part 25 for storing information for controlling the first manufacturing cell 4a.

The first cell planning device 11 according to the present embodiment includes a planning part 21 for setting a period for operating the manufacturing machines 3a, 3b and a period for conducting maintenance work. The planning part 21 of the first cell planning device 11 sets respective operation plans for the manufacturing machines 3a, 3b based on the requests for maintenance work from the manufacturing machines 3a, 3b and the manufacturing plan information from the production planning device 6, which the reception part 23 receives.

The first cell planning device 11 includes an operation program generation part 22 for generating and modifying respective operation programs of the manufacturing machines 3a, 3b. The operation program generation part 22 generates and modifies operation programs based on the operation plans for the manufacturing machines 3a, 3b set by the planning part 21. The operation program generation part 22 generates and modifies the operation program for each of the manufacturing machines 3a, 3b. The transmission part 24 transmits the operation programs to the manufacturing machines 3a, 3b. The machine control devices control the manufacturing machines 3a, 3b based on the operation programs that they receive. In the first manufacturing cell 4a, the operation is thus conducted in articles based on the manufacturing plan set by the production planning device 6.

The second cell planning device 12 controls the operations of the manufacturing machines 3a to 3c disposed in the second manufacturing cell 4b. The second cell planning device 12 is configured in the same way as the first cell planning device 11 except for including one additional manufacturing machine to be controlled. In other words, the second cell planning device 12 includes a reception part 23, a transmission part 24, and a storage part 25. The second cell planning device 12 further includes a planning part 21 and an operation program generation part 22.

The cell planning devices 11, 12 according to the present embodiment control the operations of the manufacturing machines 3a to 3c by transmitting operation programs to be generated as operation commands to the machine control devices. The cell planning devices 11, 12 may be configured in any other manner as long as they can control the operations of the manufacturing machines of corresponding manufacturing cells. For example, the machine control devices of the manufacturing machines can store a plurality of operation programs which conduct different types of operations in the storage part in advance. The operation programs are numbered. The cell planning devices can transmit the numbers of the operation programs as operation commands to the machine control devices. The machine control devices can control the manufacturing machines using the operation program corresponding to a command.

The manufacturing machines 3a to 3c conducting operations in the manufacturing cells 4a, 4b need to be placed under maintenance work. The maintenance work includes routine work. The routine maintenance work for machine tool includes, for example, washing out swarf, changing cutting tools, and changing cleaning liquid. The routine maintenance work for industrial robots includes changing grease and changing batteries.

The maintenance work also includes non-routine work. The non-routine maintenance work includes, for example, repair work for repairing a failure or malfunction of a manufacturing machine, and inspection work for inspecting a trouble of unknown cause. The repair work includes, for example, changing a deteriorated cable, changing a solenoid valve or air cylinder not functioning properly, and adjusting a sensor. The inspection work includes, for example, the work for acquiring a back-up file from the numerical control device of a machine tool or the control device of a robot. The inspection work also includes installing software used for inspection into the control device and replacing the control software of the control device with latest software. The inspection work also includes inspection of a malfunctioning communication device and countermeasure therefor.

The machine control devices of the manufacturing machines 3a to 3c according to the present embodiment are configured to transmit requests for maintenance work for the respective manufacturing machines 3a to 3c to the cell planning devices 11, 12.

The operator can input the period of routine maintenance work to the machine control devices of the manufacturing machines 3a to 3c. As for conducting non-routine maintenance work, for example, when there is a failure in a manufacturing machine 3a to 3c, the machine control device displays an alarm on a display part (display device). Having seen the alarm, the operator can set a period of maintenance work. The period of maintenance work can be set as a date and time of the start of the maintenance work and a date and time of the end of the maintenance work. Each of the machine control devices may automatically detect a trouble. Each of the machine control devices may automatically set a period of maintenance work according to the type of the trouble.

The operation of the manufacturing machines 3a to 3c needs to be suspended in order to conduct the maintenance work. However, suspending the operation of the manufacturing machines 3a to 3c entails decline in the productivity of the production system 1. In other words, the quantity of articles manufactured during the predetermined period decreases. The decreased time period for operating the manufacturing machines may make it impossible for a manufacturing cell to accomplish the processing of articles in the quantity stipulated in the manufacturing plan. The cell planning devices 11, 12 according to the present embodiment each receive the manufacturing plan of articles and a request for maintenance work. When it is impossible to accomplish the operation for the quantity of articles stipulated in the manufacturing plan in either of the manufacturing cells 4a, 4b, the manufacturing management device 5 executes a transfer control in which the operation is transferred to the other manufacturing cell.

The first manufacturing cell 4a and the second manufacturing cell 4b according to the present embodiment are configured in a manner such that at least part of the operation to be conducted in the first manufacturing cell 4a can be conducted in the second manufacturing cell. It is determined in advance whether or not the operation to be conducted in one of the manufacturing cells can be conducted in the other manufacturing cell in the manufacturing cells 4a, 4b. For example, the operation to be conducted by the first manufacturing machine 3a of the first manufacturing cell 4a can be conducted by the first manufacturing machine 3a of the second manufacturing cell 4b. The operation conducted by the second manufacturing machine 3b of the first manufacturing cell 4a can be conducted by the second manufacturing machine 3b of the second manufacturing cell 4b.

According to the present embodiment, all the operations to be conducted in the first manufacturing cell 4a can be conducted in the second manufacturing cell 4b. Further, the operations to be conducted by the first manufacturing machine 3a and the second manufacturing machine 3b in the second manufacturing cell 4b can be conducted in the first manufacturing cell 4a. However, the operation to be conducted by the third manufacturing machine 3c of the second manufacturing cell 4b cannot be conducted in the first manufacturing cell 4a. As described above, the plurality of manufacturing cells 4a, 4b according to the present embodiment are configured in a manner such that at least part of the operation can be transferred from one manufacturing cell to the other. Information as to whether or not a particular operation can be transferred between the manufacturing cells is stored in the storage part 25 of each of the cell planning devices 11, 12.

A case will be described below, as an example, in which the quantity of the articles in which the operation is conducted during the predetermined period in the first manufacturing cell 4a does not reach the quantity of articles stipulated in the manufacturing plan because of the maintenance work.

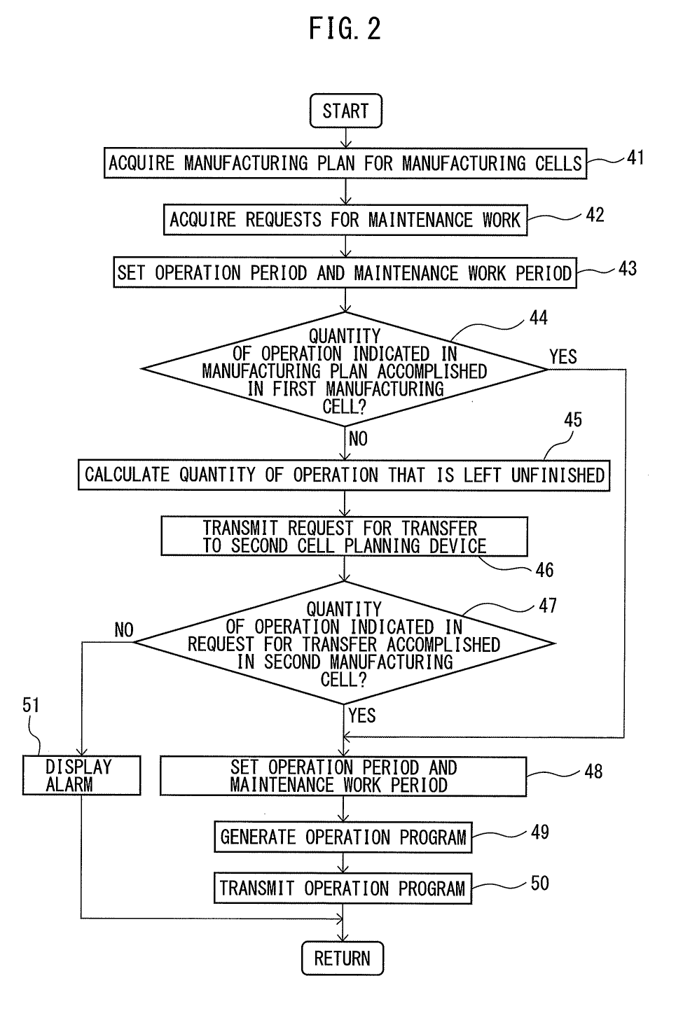

FIG. 2 shows a flow chart illustrating a control of the manufacturing management device according to the present embodiment. The control illustrated in FIG. 2 can be executed at any time. For example, the control illustrated in FIG. 2 can be executed every predetermined period. Alternatively, it can be executed every time the operator inputs information on the maintenance work into a machine control device. Furthermore, the control illustrated in FIG. 2 can be executed after a cell planning device is selected. Here, a case in which the first cell planning device is selected will be described as an example.

In step 41, each of the cell planning devices 11, 12 receives a manufacturing plan for the corresponding manufacturing cell 4a, 4b from the production planning device 6. In step 42, each of the cell planning devices 11, 12 acquires requests for maintenance work from the corresponding manufacturing machines 3a to 3c of the manufacturing cell 4a, 4b.

In step 43, the planning part 21 of the first cell planning device 11 sets the operation period and the period of maintenance work of each of the manufacturing machines 3a, 3b. The planning part 21 sets these periods based on the requests for maintenance work and the manufacturing plan. The planning part 21 of the second cell planning device 12 sets the operation period and the period of maintenance work for each of the manufacturing machines 3a to 3c. These periods may be modified later.

In step 44, the planning part 21 of the first cell planning device 11 determines whether or not the quantity of operation stipulated in the manufacturing plan will be accomplished in the first manufacturing cell 4a. For example, when components are attached to the articles in the first manufacturing cell 4a, it is determined whether or not the components can be attached to the articles in the number stipulated in the manufacturing plan within the predetermined period. When the quantity of operation stipulated in the manufacturing plan will not be accomplished in the first manufacturing cell 4a in step 44, the control proceeds to step 45.

In step 45, the planning part 21 of the first cell planning device 11 calculates the quantity of operation that would be left unfinished with respect to the quantity stipulated in the manufacturing plan. For example, the number of the articles in which the operation cannot be conducted during the predetermined period is calculated.

In step 46, the transmission part 24 of the first cell planning device 11 transmits a request for transfer including information on the quantity of operation that would be left unfinished to the second cell planning device 12. For example, when the operation to be conducted by the first manufacturing machine 3a of the first manufacturing cell 4a would be left unfinished, a request in which the first manufacturing machine 3a of the second manufacturing cell 4b conducts the operation that would be left unfinished is made. The reception part 23 of the second cell planning device 12 receives the request for transfer from the first cell planning device 11.

In step 47, the planning part 21 of the second cell planning device 12 determines whether or not the operation indicated in the request for transfer will be accomplished within the predetermined period in addition to the quantity of operation stipulated in the manufacturing plan. For example, the planning part 21 determines whether or not the period during which the manufacturing machines 3a, 3b are not operating can be used for conducting the operation. In step 47, when the quantity of operation indicated by the request for transfer will not be accomplished in the second manufacturing cell 4b, the control proceeds to step 51.

In step 51, the transmission part 24 of the second cell planning device 12 transmits a signal indicating that the request for transfer of operation is not approved to the first cell planning device 11. The first cell planning device 11 displays on the display part (display device) an alarm indicating that the operation stipulated in the manufacturing plan will not be accomplished within the predetermined period and an alarm indicating that it is not possible to transfer the operation. Note that any control can be executed in step 51. For example, the first cell planning device 11 can transmit to the production planning device 6 a notification that articles cannot be manufactured in accordance with the manufacturing plan.

In step 47, when the quantity of operation indicated by the request for transfer will be accomplished in the second manufacturing cell 4b, the planning part 21 of the second cell planning device 12 decides to conduct the operation in the second manufacturing cell 4b. The transmission part 24 of the second cell planning device 12 transmits a signal indicating that the request for transfer of operation is approved to the first cell planning device 11. At this point, the planning part 21 of the second cell planning device 12 can modify at least one of the operation period and the period of maintenance work of the manufacturing machines in the second manufacturing cell 4b so that the quantity of operation to be conducted during the predetermined period becomes more than the quantity stipulated in the manufacturing plan.

Next, the control then proceeds to step 48. The control also proceeds to step 48 when the quantity of operation stipulated in the manufacturing plan will be accomplished in the first manufacturing cell 4a in step 44. In step 48, the planning parts 21 of the cell planning devices 11, 12 determine the operation period and the period of maintenance work of the manufacturing machines 3a to 3c of the respective manufacturing cells 4a, 4b.

In step 49, the operation program generation part 22 of the first cell planning device 11 generates operation programs for the manufacturing machines 3a, 3b included in the first manufacturing cell 4a. The operation programs generated here are programs for not conducting the operation that would be left unfinished. In step 50, the transmission part 24 of the first cell planning device 11 transmits the operation programs to the respective machine control devices of the manufacturing machines 3a, 3b.

In the second cell planning device 12, the operation program generation part 22 generates operation programs for the manufacturing machines 3a to 3c included in the second manufacturing cell 4b in step 49. The operation programs generated here are programs in which the operation that would be left unfinished in the first manufacturing cell 4a is added. In step 50, the transmission part 24 of the second cell planning device 12 transmits the operation programs to the respective machine control devices of the manufacturing machines 3a to 3c.

In the second cell planning device 12, the control from the above-mentioned step 44 to step 47 can be executed after the control of the first cell planning device 11. When the quantity of operation that can be conducted in the second manufacturing cell is smaller than the quantity stipulated in the manufacturing plan, the second cell planning device 12 can transmit the request for transfer to the first cell planning device 11.

After the control illustrated in FIG. 2, articles can be manufactured in the first manufacturing cell 4a and the second manufacturing cell 4b. Manufacturing result information including the results of the operation actually conducted is transmitted to the production planning device 6. The first cell planning device 11 and the second cell planning device 12 transmit the results of operation conducted in accordance with the modified manufacturing plan to the production planning device 6.

As described above, in the present embodiment, a cell planning device transmits, when its corresponding manufacturing cell will not be able to accomplish the quantity of operation stipulated in the manufacturing plan, a request for transfer to another cell planning device for conducting the operation that would be left unfinished. The cell planning device that has received the request for transfer can conduct the operation that that would be left unfinished by modifying at least one of the operation period and the period of maintenance work in the manufacturing plan.

The production system according to the present embodiment properly ensures the period of maintenance work of the manufacturing machines and suppresses decline of productivity of the production system (decline of the quantity of operation conducted by the production system during the predetermined period). As a result, failures in the manufacturing machines can be prevented and the production capacity of the production system can be maintained at a high level. Furthermore, articles can be manufactured in a manner satisfying the manufacturing plan transmitted by the production planning device.

In the above-described embodiment, when at least part of the operation indicated in the request for transfer cannot be conducted in the second manufacturing cell, a control is executed such that an alarm is transmitted. The control is not limited to this embodiment, and when part of the operation indicated by the request for transfer can be conducted in the second manufacturing cell, part of the operation may be conducted. The first cell planning device may then indicate on the display part an alarm indicating that part of the operation stipulated in the manufacturing plan will not be conducted.

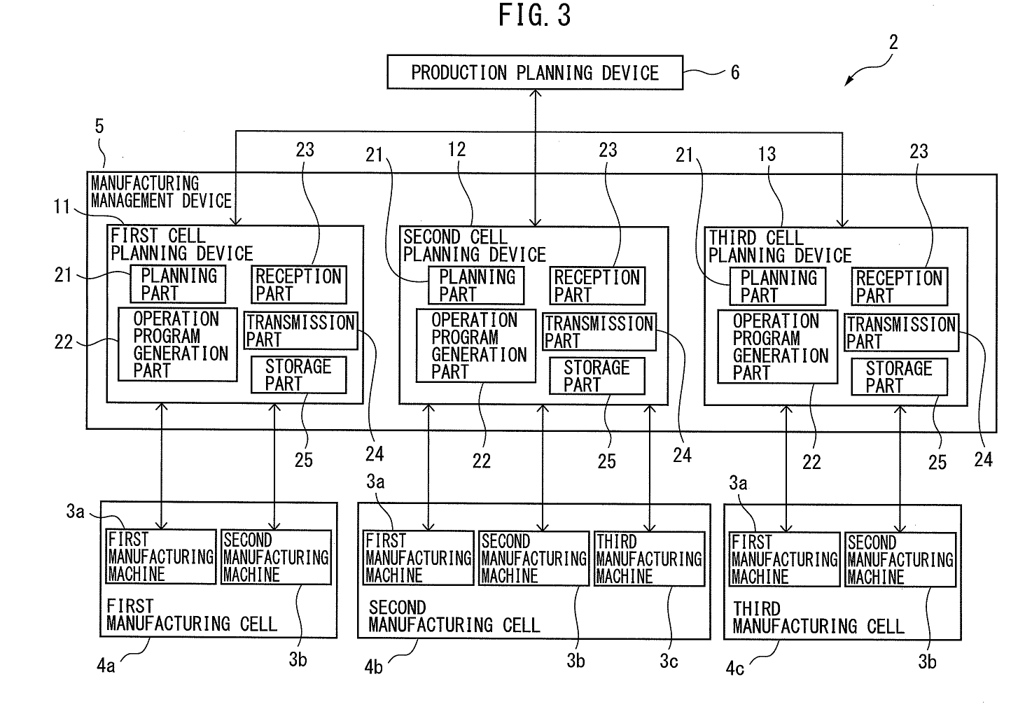

FIG. 3 illustrates a block diagram of a second production system according to the present embodiment. The second production system 2 includes two manufacturing cells 4a, 4b as well as a third manufacturing cell 4c. The third manufacturing cell 4c includes a first manufacturing machine 3a and a second manufacturing machine 3b. A manufacturing management device 5 of the second production system 2 includes third cell planning device 13 for controlling the third manufacturing cell 4c.

The third cell planning device 13 has similar configuration to the first cell planning device 11 and the second cell planning device 12. In other words, the third cell planning device 13 includes a planning part 21, an operation program generation part 22, a reception part 23, a transmission part 24, and a storage part 25. The third cell planning device 13 is configured to be communicable with the production planning device 6 by communication device. The first cell planning device 11, the second cell planning device 12, and the third cell planning device 13 are configured to be mutually communicable by communication device.

The first manufacturing cell 4a, the second manufacturing cell 4b, and the third manufacturing cell 4c are configured to be able to transfer to one another the operation to be conducted by respective first manufacturing machines 3a and second manufacturing machines 3b. For example, the operation to be conducted in the first manufacturing cell 4a can be conducted in the second manufacturing cell 4b and the third manufacturing cell 4c.

Here, a case will be described, as an example, in which quantity of operation stipulated in the manufacturing plan will not be accomplished in the first manufacturing cell 4a. The first cell planning device 11 transmits a request for transfer of operation to the second cell planning device 12.

When the quantity of operation indicated by the request for transfer received from the first cell planning device 11 will not be accomplished in the second manufacturing cell 4b, the planning part 21 of the second cell planning device 12 calculates the quantity of operation that would be left unfinished. The transmission part 24 of the second cell planning device 12 transmits a request for transfer including information on the quantity of operation that would be left unfinished to the third cell planning device 13. The planning part 21 of the third cell planning device 13 executes a control for modifying at least one of the operation period and the period of maintenance work of the manufacturing machines 3a, 3b in the third manufacturing cell 4c so as to increase the quantity of operation to be conducted during the predetermined period.

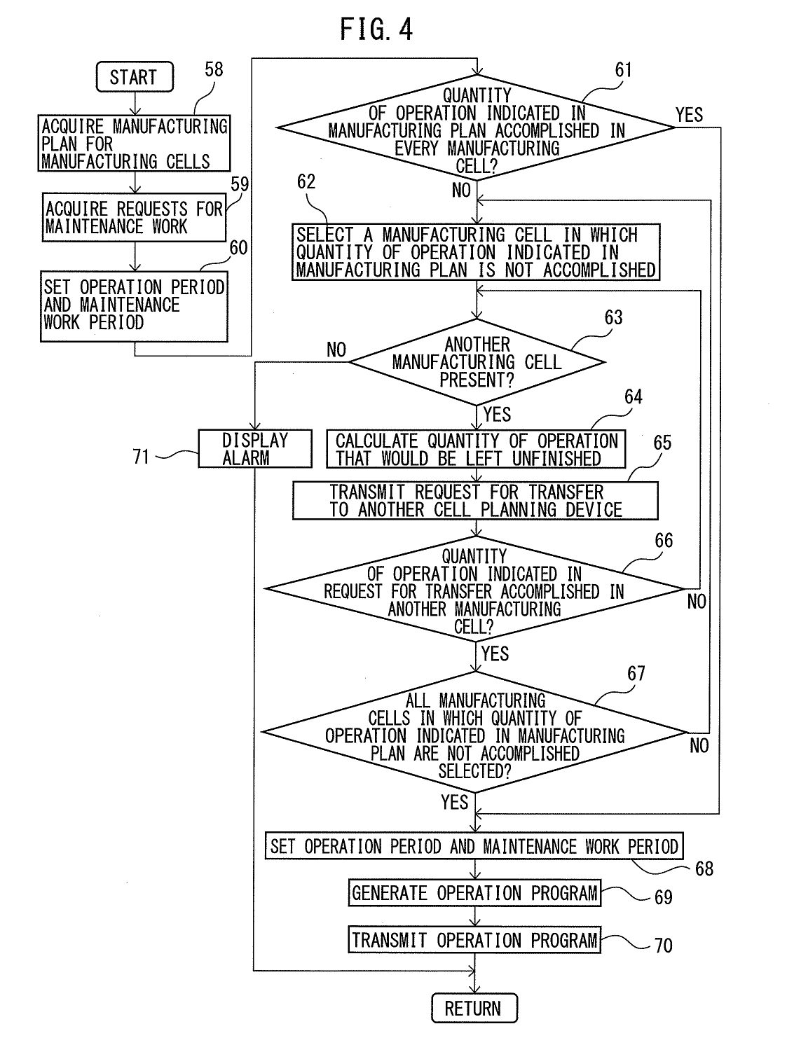

FIG. 4 illustrates a flow chart of a control of the second production system according to the present embodiment. In step 58, each of the cell planning devices 11 to 13 receives a manufacturing plan for the corresponding manufacturing cell 4a to 4c from the production planning device 6. In step 59, each of the cell planning devices 11 to 13 acquires requests for maintenance work from the manufacturing machines 3a to 3c included in the corresponding manufacturing cell 4a to 4c. In step 60, the cell planning devices 11 to 13 set the operation period and the period of maintenance work of the manufacturing machines 3a to 3c based on the manufacturing plan and the requests for maintenance work. These periods may be modified in a subsequent process.

Next, in step 61, in each of the manufacturing cells 4a to 4c, whether the quantity of operation stipulated in the manufacturing plan will be accomplished or not is determined. The planning part 21 of each of the cell planning devices 11 to 13 determines whether or not the all of operation stipulated in the manufacturing plan will be accomplished in the corresponding manufacturing cell 4a to 4c. In step 61, when the quantity of operation stipulated in the manufacturing plan will be accomplished in every manufacturing cell 4a to 4c, the control proceeds to step 68. When the quantity of operation stipulated in the manufacturing plan will not be accomplished in at least one of the manufacturing cells 4a to 4c in step 61, the control proceeds to step 62.

In step 62, a manufacturing cell in which the quantity of operation stipulated in the manufacturing plan will not be accomplished is selected. Here, a case will be described, as an example, in which the quantity of operation stipulated in the manufacturing plan will not be accomplished in the first manufacturing cell 4a.

Next, in step 63, it is determined whether or not there is another manufacturing cell in which the operation originally allocated to the first manufacturing cell 4a can be conducted. In the second production system 2, the operation originally allocated to the first manufacturing cell 4a can be conducted in the second manufacturing cell 4b and the third manufacturing cell 4c. When the operation can be conducted in another manufacturing cell in step 63, the control proceeds to step 64.

In step 64, the planning part 21 of the first cell planning device 11 calculates the quantity of operation that would be left unfinished in the first manufacturing cell 4a. In step 65, the transmission part 24 of the first cell planning device 11 selects a cell planning device to which a request for transfer of operation is to be transmitted. Here, the transmission part 24 of the first cell planning device 11 transmits a request for transfer of operation to the second cell planning device 12.

In step 66, the planning part 21 of the second cell planning device 12 determines whether or not the quantity of operation indicated by the request for transfer will be accomplished in the second manufacturing cell 4b. When all of the operation that would be left unfinished in the first manufacturing cell 4a will be accomplished in the second manufacturing cell 4b in step 66, the control proceeds to step 67.

When at least part of the operation indicated by the request for transfer will be left unfinished in the second manufacturing cell 4b in step 66, the control proceeds to step 63. In step 63, the planning part 21 of the second cell planning device 12 determines whether or not there is yet another manufacturing cell. In the present example, the operation can be conducted in the third manufacturing cell 4c.

In step 64, the planning part 21 of the second cell planning device 12 calculates the quantity of operation that would be left unfinished in the second manufacturing cell 4b. In step 65, the transmission part 24 of the second cell planning device 12 transmits a request for transfer of operation to the third cell planning device 13.

In step 66, the planning part 21 of the third cell planning device 13 determines whether or not the quantity of operation indicated by the request for transfer will be accomplished. When the remaining amount of operation will not be accomplished even in the third manufacturing cell 4c in step 66, the control returns to step 63. In step 63, it is determined that there are no other manufacturing cells in which the operation originally allocated to the first manufacturing cell 4a will be accomplished, and the control proceeds to step 71.

In step 71, an alarm is displayed, for example, on a display part disposed in the first cell planning device 11, indicating that the quantity of operation stipulated in the manufacturing plan will not be accomplished. The control then terminates.

When all of the operation that would be left unfinished in the first manufacturing cell 4a will be accomplished in the second manufacturing cell 4b and the third manufacturing cell 4c in step 66, the control proceeds to step 67.

In step 67, it is determined whether or not all the manufacturing cells in which the quantity of operation stipulated in the manufacturing plan will not be accomplished have been selected. When there still is a manufacturing cell in which the quantity of operation stipulated in the manufacturing plan will not be accomplished in step 67, the control proceeds to step 62. In step 62, a manufacturing cell in which the quantity of operation stipulated in the manufacturing plan will not be accomplished is selected anew. After that, the control from step 63 to step 66 is executed. When all the manufacturing cells in which the quantity of operation stipulated in the manufacturing plan will not be accomplished have been selected in step 67, the control proceeds to step 68.

In step 68, the planning parts 21 of the cell planning devices 11 to 13 set the operation period and the period of maintenance work of the manufacturing machines 3a to 3c during the predetermined period.

Note that a cell planning device that has received a request for transfer determines whether or not the operation indicated by the request for transfer will be accomplished. After that, the cell planning device that has received the request for transfer transmits the result of its determination to the cell planning device that has transmitted the request for transfer.

In step 69, the operation program generation parts 22 of the cell planning devices 11 to 13 generate operation programs for the manufacturing machines 3a to 3c of the respective manufacturing cells 4a to 4c. In step 70, the transmission parts 24 of the cell planning devices 11 to 13 transmit the operation programs to the machine control devices of the respective manufacturing cells 4a to 4c. After that, in each of the manufacturing cells 4a to 4c, the manufacturing machines 3a, 3b operate in accordance with the operation programs so as to manufacture articles.

In the second production system according to the present embodiment, the manufacturing management device 5 includes three or more cell planning devices connected in relation to three or more manufacturing cells. When requested quantity of operation will not be accomplished in a cell planning device, the cell planning device calculates the quantity of operation that would be left unfinished with respect to the requested quantity of operation. The cell planning device executes the transfer control for transmitting a request for transfer including information on the quantity of operation that would be left unfinished to another cell planning device. The manufacturing management device 5 repeats the transfer control until the quantity of operation stipulated in the manufacturing plan will be accomplished.

The control in the second production system enables effective allocation among a plurality of manufacturing cells of operation that will not be accomplished in one manufacturing cell when the maintenance work is conducted. In the production system including three or more manufacturing cells, it is possible to examine whether or not the operation that would be left unfinished will be accomplished in all of manufacturing cells. As a result, the production system decreases instances in which the quantity of operation stipulated in the manufacturing plan fails to be accomplished within the predetermined period.

In the above-described embodiment, the operation that would be left unfinished in the first manufacturing cell is transferred to the second manufacturing cell. When some operation would be left unfinished also in the second manufacturing cell, the operation that would be left unfinished in the second manufacturing cell is transferred to the third manufacturing cell. The transfer control is not limited to this manner, and a request for transfer can be transmitted to any cell planning device in which the operation that would be left unfinished can be conducted. For example, when the quantity of operation stipulated in the manufacturing plan will not be accomplished in the first manufacturing cell, the request for transfer may be transmitted to the third cell planning device. An order of the cell planning devices as target for transmitting the request for transfer may be determined in advance. Alternatively, one cell planning device may transmit the request for transfer to a plurality of cell planning devices.

Note that in each cell planning device, when the requested quantity of operation will not be accomplished within the predetermined period, a control in any way for increasing the quantity of operation can be executed before transmitting the request for transfer. For example, the processing speed of the manufacturing machines may be increased within allowable limit. In other words, the control for increasing the quantity of operation during the predetermined period may be executed by increasing the speed of the manufacturing machines.

According to the present invention, a manufacturing management device that suppresses the decrease in productivity due to maintenance work of the manufacturing machines is provided.

In each control described above, the order of steps can be changed as appropriate as long as the functions and effects are not changed. The above-described embodiments can be combined as appropriate.

Throughout the drawings referred to above, the same and equivalent parts are denoted by the same reference numerals. It should be noted that the above-described embodiments are illustrative only and not intended to limit the invention in any way. The embodiments also include modifications on the embodiments described in the claims.

1. A manufacturing management device that is connected to a production planning device for setting a manufacturing plan of articles and controls first manufacturing cell including a manufacturing machine and second manufacturing cell including a manufacturing machine, the manufacturing management device comprising:
first cell planning device connected to the manufacturing machine of the first manufacturing cell; and
second cell planning device connected to the manufacturing machine of the second manufacturing cell;
wherein each of the cell planning devices includes:
a reception part for receiving a request for maintenance work from the manufacturing machine and quantity stipulated in the manufacturing plan for a predetermined period from the production planning device;
a planning part for setting a period during which the manufacturing machine is operated and a period during which the maintenance work is conducted based on the request for maintenance work and the manufacturing plan; and
a transmission part for transmitting predetermined information to the other cell planning device;
wherein the planning part of the first cell planning device, when the quantity of operation stipulated in the manufacturing plan is not accomplished, calculates quantity of operation that is left unfinished with respect to the quantity stipulated in the manufacturing plan,
the transmission part of the first cell planning device transmits a request for transfer including information on the quantity of operation that is left unfinished to the second cell planning device; and
the planning part of the second cell planning device, when the request for transfer is received from the first cell planning device, modifies at least one of the operation period and the period of maintenance work of the manufacturing machine in the second manufacturing cell so as to increase the quantity of operation during the predetermined period.

2. The manufacturing management device according to claim 1, further comprising three or more cell planning devices connected in relation to three or more manufacturing cells,
wherein each of the cell planning devices is configured in such a manner that, when a requested quantity of operation is not be accomplished in the cell planning device, the cell planning device executes a transfer control for, after calculating quantity of operation that is left unfinished with respect to the requested quantity of operation, transmitting a request for transfer including information on the quantity of operation that is left unfinished to another cell planning device, and
a plurality of the cell planning devices repeat the transfer control until it is found that the quantity of operation stipulated in the manufacturing plan is accomplished.

3. The manufacturing management device according to claim 1 that is connected to the production planning device and controls third manufacturing cell including a manufacturing machine, further comprising third cell planning device connected to the manufacturing machine of the third manufacturing cell,
wherein, when the quantity of operation indicated by the request for transfer is not accomplished in the second manufacturing cell, the planning part of the second cell planning device calculates quantity of operation that is left unfinished with respect to the request for transfer,
the transmission part of the second cell planning device transmits to the third cell planning device a request for transfer including information on the quantity of operation that is left unfinished, and
the planning part of the third cell planning device, when the request for transfer is received from the second cell planning device, modifies at least one of the operation period and the period of maintenance work of the manufacturing machine in the third manufacturing cell so as to increase the quantity of operation during the predetermined period.
